(19) United States
(12) Patent Application Publication
(10) Pub. No.: US 2018/0149269 A1
(43) Pub. Date: May 31, 2018

(54) MOLDED SEAL AND FITTING WITH SUCH A MOLDED SEAL

(71) Applicant: Endress+Hauser Conducta GmbH+Co. KG, Gerlingen (DE)

(72) Inventors: Felix Schneider, Dresden (DE); Thomas Pfauch, Leipzig (DE); Ingrid Wunderlich, Radebeul (DE)

(21) Appl. No.: 15/809,127

(22) Filed: Nov. 10, 2017

(30) Foreign Application Priority Data
Nov. 28, 2016 (DE) 10 2016 122 889.3

(51) Int. Cl. F16J 15/10

(52) U.S. Cl. CPC F16J 15/104; F16J 15/102

(57) ABSTRACT

The present disclosure relates to a molded seal for sealing an annular gap between an outer peripheral wall and an inner peripheral wall against a medium, including at least a first annular sealing body portion, facing the medium, to be placed between the outer and inner walls, and a second annular sealing body portion, facing away from the medium, to be placed between the outer and inner walls. The second sealing body portion facing the inner wall includes an annular cavity and at least one groove on its end face facing away from medium, where the cavity and groove are connected to each other. Moreover, the present disclosure relates to a fitting comprising such a molded seal.

### CROSS-REFERENCE TO RELATED APPLICATION

The present application is related to and claims the priority benefit of German Patent Application No. 10 2016 122 889.3, filed on Nov. 28, 2016, the entire contents of which are incorporated herein by reference.

### TECHNICAL FIELD

The present disclosure relates to a molded seal and a fitting in particular, an exchangeable fitting or a fixed fitting with such a molded seal.

### BACKGROUND

In this context, a fitting means a fixed fitting, installed fitting, process fitting, or flow fitting. A fitting serves for installing sensors in basins, channels, tanks, or, in general, containers. The fitting possesses a connection for attaching to basins, channels, or tanks, as well as a connection for attaching sensors. It accordingly constitutes an adapter, so that sensors can be incorporated in the process.

Exchangeable fittings are for removing sensors from the process, and accordingly the medium, without interrupting the process, and then reintroducing them into the process. The sensors are fastened to a seat, such as in a dip tube, and are moved axially by hand or automatically, e.g., pneumatically, by means of a drive between a process position (measurement) and a service position (maintenance, calibration, rinsing, probe exchange, etc.). These procedures run within a certain time cycle, or as a function of other determinable or measured parameters.

A great variety of exchangeable fittings are offered and marketed by the Endress+Hauser Group of companies, for example, under the name of “Cleanfit H CPA875.”

Sensors serve to measure one or more physical or chemical process variables. Sensors are used to determine process variables, wherein the sensors can, for example, be pH sensors, conductivity sensors, optical or electrochemical sensors for determining a concentration of a substance contained in the medium to be monitored, such as O₂, CO₂, certain types of ions, organic compounds, etc.

As mentioned, sensors are attached to or placed in a seat in order to bring them into contact with the medium. The seat comprises a seal around the sensor that seals the interior of the fitting from the medium. One design of the seal comprises an O-ring. However, this leads to an unhygienic design due to the O-ring groove, which gives rise to a gap. Moreover, the bacterial density is problematic due to the short sealing length of the O-ring. FIG. 1 shows a possible fitting 100 with its housing 130, sensor 30, and O-ring 0. The additional disadvantage that the seal can be pressed out when installing the sensor is also evident.

### SUMMARY

The aim of the present disclosure is to provide a seal and a fitting that satisfy hygienic requirements. In particular, leakage recognition should be feasible.

The aim is achieved with a molded seal comprising at least a first annular sealing body portion, facing the medium, to be placed between the outer and inner walls, and a second annular sealing body portion, facing away from the medium, to be placed between the outer and inner walls, wherein the second sealing body portion facing the inner wall comprises an annular cavity, wherein the second sealing body portion comprises at least one groove on its end face facing away from medium, and wherein the cavity and groove are connected to each other.

In order to be able to recognize a failure of the first sealing body portion, the second sealing body portion comprises one or more grooves. In a failure, the medium to be sealed then flows out of cavity through the grooves. This can be easily recognized, and, optionally, detected automatically.

In an embodiment, the second sealing body portion comprises several evenly-distributed grooves. The grooves are distributed in circles on the annular end face.

In certain embodiments, the second sealing body portion is radially larger than the first sealing body portion so as to achieve an improved sealing effect and to take into account thermal expansion. The advantage to this design is especially revealed when seals with the same geometry, but with a different material, are used.

The groove or grooves have rounded contours and/or the groove or grooves are flattened radially to the outside, so that the medium to be sealed can drain more effectively.

In another advantageous development, the material of the molded seal is ethylene propylene rubber (EPM), ethylene propylene diene rubber (EPDM), a fluorinated rubber (FKM), perfluorinated rubber (FFKM), polytetrafluorethylene (PTFE), or a silicone.

The aim is also achieved with a fitting in particular, an exchangeable fitting comprising a molded seal as described above, wherein the fitting comprises a seat for a sensor for measuring at least one measurand of a medium in a container and seals the molded seal between the sensor and seat against the medium.

In one embodiment, the fitting comprises at least one opening in particular, a leak hole that is arranged on the side, facing away from the medium, of the molded seal and is connected to the cavity and the groove. Any failure of this seal can thereby be recognized at the opening.

In certain embodiments, a detection unit for detecting the medium is connected to the opening in particular, to the leak hole. This immediately and automatically identifies a leak.

### BRIEF DESCRIPTION OF THE DRAWINGS

The present disclosure will be explained in more detail with reference to the following figures. These show:

FIG. 1 shows an exemplary fitting;

FIG. 2 shows a cross-section of an embodiment of a molded seal of the present disclosure after being installed;

FIG. 3 shows a molded seal of the present disclosure; and

FIG. 4 shows another view of a cross-section of a molded seal of the present disclosure after being installed.

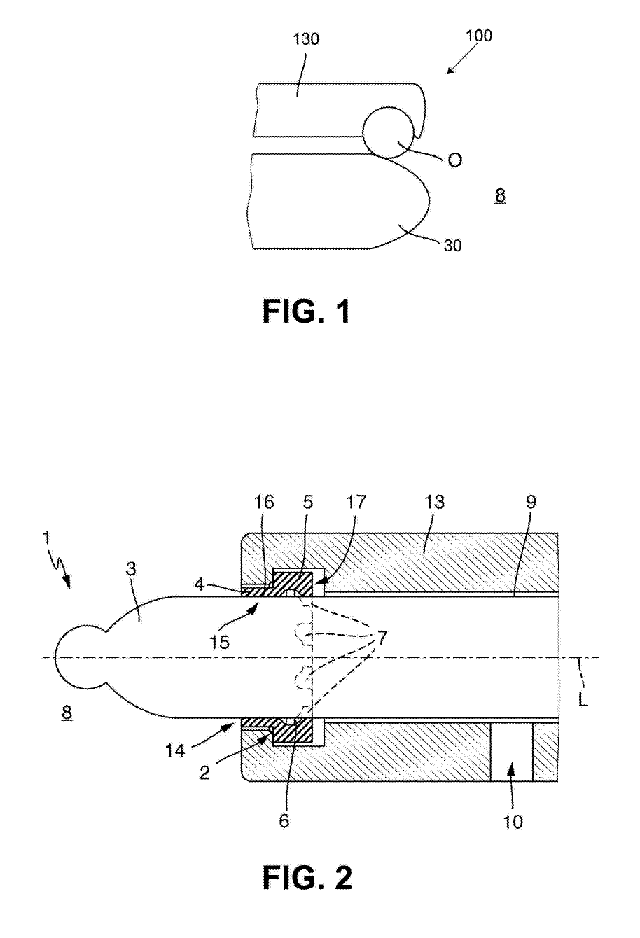

### DETAILED DESCRIPTION

In the figures, the same features are identified with the same reference characters.

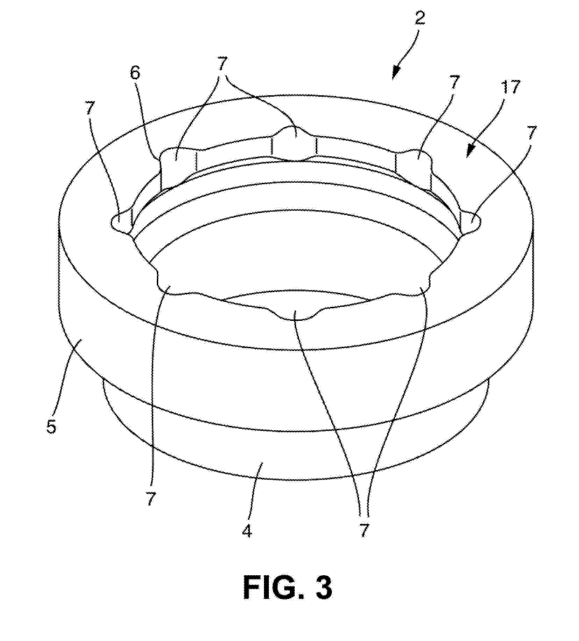

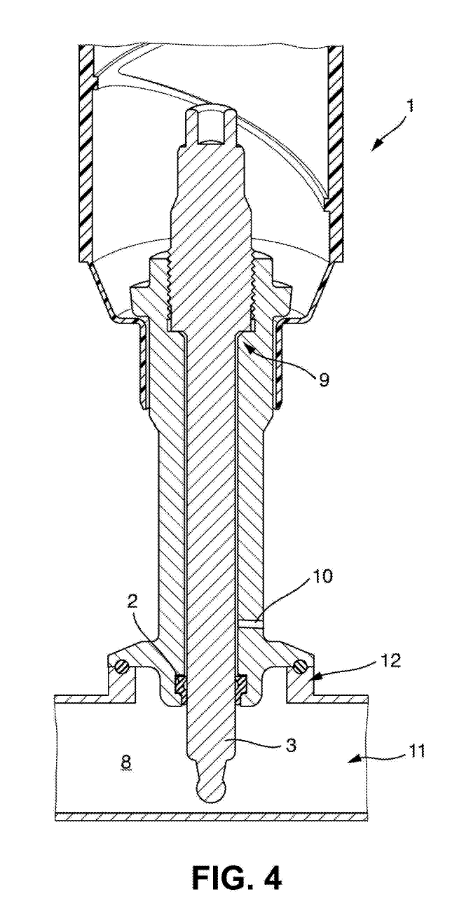

The claimed fitting has reference sign 1 and is portrayed in FIG. 2 and, in particular, FIG. 4. The fitting 1 is designed as either an exchangeable or a fixed fitting. A fixed fitting is depicted. The principle of the claimed molded seal 2 can also be used in an exchangeable fitting.

The fitting 1 consists of a substantially cylindrical fitting housing 13 which can be connected to a container 11 by means of a process connection 12. The process connection 12 can be designed as, for example, a flange connection made, for example, of stainless steel. The medium 8 to be measured is located in the container 11. The container 11 can, for example, be a tank, boiler, tube, pipeline, etc.

The terms “top,” “above,” and related terms mean, according to the present disclosure, facing away from the medium 8. “Bottom,” “below,” and related terms mean, according to the present disclosure, facing toward the medium 8. “Outer,” “outside,” and related terms mean, according to the present disclosure, away from the longitudinal axis L of the housing 13. “Within,” “inside,” and related terms mean, according to the present disclosure, towards the longitudinal axis L.

If the fitting 1 is designed as an exchangeable fitting as shown, the sensor 3 is mounted so as to move axially in the direction of the medium 8, or in the direction facing away from the medium 8 along the central axis L. The sensor 3 thus proceeds between the service position retracted into the housing 13 and the process position extended from the housing 13, i.e., the sensor 3 in this position is in contact with the medium 8, and measurement occurs. FIG. 4 shows the process position.

Within the housing 13, a seat 9 for the sensor 3 is guided, i.e., the sensor 3 is connected to the seat 9 for example, by a screw connection. The seat 9 is part of the movable dip tube (not shown in more detail). The sensor 3 serves to measure one or more physical or chemical process variables. These are, for example, the pH value also through an ISFET redox potential, absorption of electromagnetic waves in the medium 8, such as with wavelengths within the UV, IR, and/or visible ranges, oxygen, conductivity, opacity, concentration of metal and/or non-metal materials, or the temperature.

When the seat 9 is in the service position, the sensor 3 in the interior is within the so-called service chamber (not shown) for rinsing, cleaning, calibrating, etc. A wide variety of service tasks such as cleaning or calibration can be performed in the service position. Cleaning liquid, rinsing liquid, and calibration liquid can be injected into the interior through a connection (not shown) to the interior. The liquid can drain through a corresponding additional outlet.

The dip tube and the seat 9 can be produced from various materials. Dip tubes made of stainless steel, titanium, or other chemically-resistant materials are known from the prior art. The dip tube can also be made of a plastic such as polyetheretherketone (PEEK), polytetrafluorethylene (PTFA), a perfluoroalkoxy polymer (PFA), another plastic, or resistant metals such as Hastelloy. The same holds true for the housing 13.

The sensor 3 is made to move, for an exchangeable fitting 1, by a manual or automatic drive, e.g., by means of a supply energy (not shown). When supply energy is introduced by a connection (not shown), the sensor 3 moves from the service position into the process position. Another connection (also not shown) then serves as an outlet. If supply energy is introduced in the reverse direction, the dip tube moves from the process position into the service position. Pneumatic, hydraulic, or electric drives are known from the prior art.

In the following, the molded seal 2 for sealing the seat 9 from the container 11 or medium 8 will be further described. The molded seal 2 is shown individually enlarged in FIG. 3, and in the installed situation in the fitting 1 in FIG. 2.

The fitting 1 or the seat 9 comprises an annular gap 14 through which the sensor 3 is advanced. The molded seal 2 seals the annular gap 14 between an outer wall 16 that is formed by the housing 13 and an inner wall 15 that is formed by the sensor 3. The seal 2 seals the interior of the fitting 1 against the medium 8.

The seal 2 is designed to be annular. The seal 2 comprises a first annular sealing body portion 4 and a second annular sealing body portion 5. The second sealing body portion 5 has a greater outer diameter than the first sealing body portion 4. The first sealing body portion 4 is arranged toward the medium, and the second sealing body portion 5 is arranged facing away from the medium.

Toward the inside, the second sealing body portion 5 comprises an annular cavity 6. The second sealing body portion 5 further comprises one or more grooves 7 that are arranged on the end face 17, facing away from the medium, of the sealing body portion 5. The grooves 7 for example, eight of them are distributed evenly over the perimeter, and are then arranged at an angle of 45° relative to each other.

The cavity 6 and grooves 7 are in (fluidic) contact with each other, which will be further explained in the following paragraph. The grooves 7 have rounded contours so that the medium 8 can flow more easily. Likewise, the grooves 7 are flattened radially to the outside in order to amplify this effect, or to let the medium 8 drain more easily. By means of the process pressure, the medium 8 is pressed “upwards” and drains through the molded seal 2.

In order to be able to recognize a leak in the event of a failure of the first sealing body portion 4, the second sealing body portion 5 comprises one or more grooves 7. In case of a failure, the medium 8 thereby then flows out of the cavity 6 through the grooves 7 and exits the opening 10 in the fitting 1. The opening 10 can, for example, be designed as a leak hole. A corresponding detection device (not shown) can also be connected to the opening 10. The opening 10 is arranged on the side of the seal 2 opposite from the medium.

The molded seal 2 is, for example, made of an ethylene propylene rubber (EPM), ethylene propylene diene rubber (EPDM), a fluorinated rubber (FKM), perfluorinated rubber (FFKM), polytetrafluorethylene (PTFE), or a silicone.

1. A molded seal for sealing an annular gap against a medium between an outer peripheral wall and an inner peripheral wall, comprising:
a first annular sealing body portion, adjacent the medium, disposed between the outer peripheral wall and inner peripheral wall; and
a second annular sealing body portion, opposite the medium, disposed between the outer peripheral wall and inner peripheral wall, the second annular sealing body portion having an end face opposite the medium,
wherein the second sealing body portion includes an annular cavity adjacent the inner peripheral wall and includes at least one groove on the end face, and
wherein the cavity and the at least one groove are connected to each other.

2. The molded seal of claim 1, wherein the second sealing body portion comprises several evenly distributed grooves.

3. The molded seal of claim 1, wherein the second sealing body portion is radially larger than the first sealing body portion.

4. The molded seal of claim 1, wherein the at least one groove has rounded contours.

5. The molded seal of claim 1, wherein the at least one groove is flattened radially to the outside.

6. The molded seal of claim 1, wherein the material of the molded seal is ethylene propylene rubber, ethylene propylene diene rubber, a fluorinated rubber, perfluorinated rubber, polytetrafluorethylene, or a silicone.

7. The molded seal of claim 1, the molded seal comprising a plurality of grooves.

8. An exchangeable fitting for analytical process engineering, comprising:
a molded seal, the molded seal including:
a first annular sealing body portion, adjacent the medium, disposed between the outer peripheral wall and inner peripheral wall; and
a second annular sealing body portion, opposite the medium, disposed between the outer peripheral wall and inner peripheral wall, the second annular sealing body portion having an end face opposite the medium,
wherein the second sealing body portion includes an annular cavity adjacent the inner peripheral wall and includes at least one groove on the end face, and wherein the cavity and the at least one groove are connected to each other; and
a seat for a sensor for measuring at least one measurand of a medium in a container, the seat embodied to seal the molded seal between the sensor and seat against the medium.

9. The exchangeable fitting of claim 8, the fitting further comprising at least one opening arranged on a side of the molded seal opposite the medium, the at least one opening in communication with the cavity and the at least one groove.

10. The exchangeable fitting of claim 9, wherein the at least one opening is structured as a leak hole.

11. The exchangeable fitting of claim 9, wherein a detection unit for detecting the medium is connected to the opening.
